(19) United States
(12) Patent Application Publication
(10) Pub. No.: US 2026/0243683 A1
(43) Pub. Date: Aug. 20, 2026

(54) LIGHT MICROSCOPY METHOD, LIGHT MICROSCOPY DEVICE, AND COMPUTER PROGRAM

(71) Applicant: ABBERIOR INSTRUMENTS GMBH, Gottingen (DE)

(72) Inventors: Andreas SCHONLE, Gottingen (DE); Joachim FISCHER, Karlsruhe (DE)

(21) Appl. No.: 19/537,798

(22) Filed: Feb. 12, 2026

(30) Foreign Application Priority Data
Feb. 17, 2025 (DE) 10 2025 105 762.1

(51) Int. Cl. G01N 21/64

(52) U.S. Cl. CPC G01N 21/6458; G01N 2201/06146; G01N 2201/0697

(57) ABSTRACT

A light microscopy method including illuminating a sample with focused pulsed excitation light to excite at least two types of emitters with different emission lifetimes to emit light, and illuminating the sample with an intensity distribution of inhibition light comprising a local minimum to de-excite emitters outside the local minimum, detecting photons emitted from the sample by a detector, performing a phasor analysis based on the detected photons to separate photons from the different types of emitters based on their emission lifetimes, and performing a gating of the photons, wherein respective gating time intervals are provided for excitation pulses of the excitation light, and wherein only those photons detected in the respective gating time interval are taken into account in the phasor analysis, as well as a light microscopy device and a computer program for carrying out the method.

### CROSS-REFERENCE TO RELATED APPLICATIONS

The present application claims the benefit of and priority to DE Patent Application Serial No. DE 10 2025 105 762.1, filed Feb. 17, 2025, the entire contents of which is incorporated herein by reference.

### TECHNICAL FIELD

The present disclosure relates to a light microscopy method, in particular using inhibition light to increase resolution, and a lifetime analysis to separate the signals of different emitters. Further aspects of the present disclosure are a device and a computer program for carrying out the method.

### PRIOR ART

In light microscopy, a lifetime analysis, in particular a fluorescence lifetime analysis, can be used, for example, to separate the signals of different types of emitters, in particular fluorophores or sample structures labeled with fluorophores. In this way, signals from emitters that have a strongly overlapping or even identical emission spectrum, i.e., whose emitted light cannot be separated using wavelength-dependent optical filters, for example, can also be separated as long as the emitters have different lifetimes. Lifetime is understood here in particular as the average time after excitation by excitation light after which a photon is emitted. For fluorescent dyes commonly used in fluorescence microscopy, lifetimes are typically in the range of fractions of nanoseconds to several nanoseconds.

Lifetimes can be determined experimentally, e.g., by time-correlated single photon counting (TCSPC). In this process, the sample is periodically illuminated with excitation laser pulses and the detection light from the sample (particularly fluorescence light) is detected by a detector that is capable of detecting individual photons and determining their arrival time at the detector with an accuracy in the picosecond range, e.g., an avalanche photodiode coupled to appropriate evaluation electronics. From the time difference between a large number of photon signals and the respective preceding laser pulse, a temporal distribution of the arrival times can be determined, which may be represented as a histogram, for example. The lifetime can be determined from this histogram, e.g., by function fit or phasor plot analysis (see below). As an alternative to time-correlated single photon counting, a lifetime analysis can also be performed based on frequency data by widefield illumination of a sample with time-modulated light and recording the emission signals with a camera capable of gating. In this case, the lifetime of emitters can be determined from the phase shift between the periodic excitation and the modulated emission signal, as well as from the modulation depth.

A lifetime analysis based on time data, i.e., using time-correlated single photon counting, can be performed, for example, with a confocal laser scanning microscope, wherein the laser pulses are focused into the sample, the laser focus is scanned through the sample, e.g., with a galvo scan device, and pixel intensities of a scan image are calculated from the intensities or photon counts of the detection light detected at the various sample positions. In addition to the total intensity, a lifetime analysis can be performed for each pixel. This usually involves analyzing the arrival times of a large number of photons for each sample position.

Lifetimes can be determined, for example, by fitting the arrival time distribution to a monoexponential or multiexponential function. If the signal originates from a single emitter species whose arrival times are monoexponentially distributed (this is the case for many fluorescent dyes), the corresponding signal can be assigned to an emitter species in this way.

In case of a mixed signal originating from several emitter types with different lifetimes, the proportion of the different emitter types in the signal can in principle be determined by fitting the arrival time data to a multi-exponential function. In this way, the signals can be separated and, for example, two scan images of different lifetime channels can be calculated and displayed.

However, separating emission signals using functional fitting is challenging and error-prone, particularly in case of weak signals, i.e., relatively few detected photons, particularly since the underlying model of the functional fit is not known in advance and there are no clearly defined criteria for when a match with the model exists.

As an alternative to functional fitting, phasor plot analysis allows graphical evaluation of lifetime data and is basically capable of separating the signals from emitters with different characteristic lifetimes.

In phasor plot analysis based on arrival time data (i.e., in particular TCSPC-based), the coordinates of a phasor, namely a real part

$$g ( ω ) = \frac{{\int }_{0}^{∞} I ( t ) cos ( ω t )}{{\int }_{0}^{∞} I ( t )}$$

and an imaginary part

$$s ( ω ) = \frac{{\int }_{0}^{∞} I ( t ) sin ( ω t )}{{\int }_{0}^{∞} I ( t )} ,$$

determined for each scan pixel, wherein ω corresponds to the repetition rate of the pulsed light source multiplied by 2π, and wherein I(t) is the decay function or the temporal distribution of the detected photon numbers. The real part g(ω) corresponds to the cosine transform of the arrival time data, and the imaginary part s(ω) corresponds to the sine transform of the arrival time data.

The phasors can be graphically represented in a g/s coordinate system, with each pixel corresponding to a data point (known as a phasor plot).

Pixels containing pure signals from an emitter with a single characteristic lifetime are arranged in the phasor plot on a semicircle with center (0.5;0) and radius 0.5. The longer the lifetime, the closer the corresponding phasor is to the point (0,0), and the shorter the lifetime, the closer the phasor is to the point (1,0). Therein, the phasor (0,0) is the limit value for the lifetime ∞, and the phasor (1,0) is the limit value for the lifetime 0.

Under ideal conditions, mixtures of two signals, e.g., pixels containing emitters of several different species, lie on a connecting line between the two corresponding pure lifetime components (i.e., on a secant of the semicircle), with the position on the line depending on the mixing ratio of the signals. For example, the phasor of a pixel whose signal consists of two lifetime components, each accounting for 50%, lies at the midpoint of a connecting line between the phasors of the corresponding pure lifetime components.

In this way, the pixel intensities can be assigned to different detection channels (emitter species) according to their position on the secant, so a scan image with a mixed signal can be separated into two scan images of the corresponding detection channels (so-called lifetime unmixing).

Due to measurement errors and noise, phasor data typically scatter around the ideal positions described above on the phasor plot.

STED microscopy enables light microscopic imaging with super resolution (so-called super resolution microscopy), a better spatial resolution than the Abbe diffraction limit of classical light microscopy.

Prior art STED microscopes are based on confocal laser scanning microscopes, wherein the excitation focus is superimposed with a light distribution of STED (stimulated emission depletion) light with a central zero intensity point. The STED light transmits excited fluorophores in the area around the zero intensity point from the excited state back to the ground state without emitting fluorescent light. In this way, the effective detection point spread function can be narrowed to values well below the diffraction limit, i.e., the fluorescence light detected for a pixel originates predominantly from an area close to the zero intensity point.

A combination of STED microscopy with TCSPC-based lifetime analysis is known from the prior art (E. Auksorius et al., “Stimulated emission depletion microscopy with a supercontinuum source and fluorescence lifetime imaging” (2008), Optics Letters 33 (2), 113-115).

Additional STED light has a spatially and temporally complex influence on the lifetime of the emitters in the sample. In addition to the spontaneous decay of the excited fluorophores, fluorophores illuminated with STED light can transition to the ground state without light emission due to the STED effect, at a rate that differs from the rate of decay due to fluorescence and depends on the local STED light intensity, i.e., the spatial distribution of the fluorophores within the illuminated area.

STED microscopy can be performed with both pulsed STED light (known as p-STED) and continuous illumination with STED light (CW-STED). In p-STED, the STED pulse is often delayed relative to the excitation pulse to increase the effectiveness of stimulated emission.

In the CW-STED method with pulsed excitation light and continuously irradiated STED light, the spatial resolution can be increased by so-called time gating. This involves blocking the photons detected during a time interval after the excitation pulse or not using them for image calculation (G. Vicidomini et al., “Sharper low-power STED nanoscopy by time gating” (2011), Nature Methods 8(7), 571-573). This filters out photons with a shorter lifetime, which are more likely to have been spontaneously emitted before the STED light could return the corresponding emitter to its ground state. A disadvantage of CW-STED with gating is that photons with a short lifetime are also filtered out of the central region of the effective PSF, resulting in a loss of usable signal.

P-STED with time gating is also known from the prior art (G. Vicidomini et al., “STED Nanoscopy with Time-Gated Detection: Theoretical and Experimental Aspects (2013), PLoS ONE 8(1): e54421. doi:10.1371/journal.pone.0054421), but in this case, gating only results in a minimal increase in spatial resolution.

From the publication “Encoding and decoding spatio-temporal information for super-resolution microscopy” (2015) by L. Lanzano et al., Nat Commun 6, 6701 (2015), https://doi.org/10.1038/ncomms7701, a method is known in which the resolution of CW-STED images is increased by means of phasor plot analysis. In this method, faster and slower lifetime components of the fluorescence signal are separated from each other by solving a linear system of equations.

A similar method for increasing resolution based on phasor analysis is described in the publication “Photon separation to enhance the spatial resolution of pulsed STED microscopy” (2019) by G. Tortarolo et al., Nanoscale 11, 1754-1761, for pulsed STED microscopy. Due to the even more complex spatial-temporal distribution of the lifetime components, a simulation of the emitter distribution is used here instead of solving a linear equation system.

In “A novel pulsed STED microscopy method using FastFLIM and the phasor plots” (2017) by Y. Sun et al., Proc. of SPIE Vol. 10069 100691C-1, a method is described in which STED microscopy is combined with TCSPC analysis and phasor plots. In phasor plot analysis, based on prior knowledge of the position of phasors of the pure lifetime component without STED light and at different STED light intensities, a binary mask is applied to filter out the unwanted low-resolution components.

In the application note “TauSTED: pushing STED beyond its limits with lifetime” by L.A.J. Alvarez (2021) Nature Methods, a method called “TauBackgroundSuppression” is described in which a phasor plot of time-resolved STED microscopy data is generated and phasors on an “STED trajectory” are separated in the phasor plot by applying a binary mask of uncorrelated background signals in other areas of the phasor plot. On the other hand, in a method called “TauStrength,” phasors are assigned different weights according to their position on the “STED trajectory,” which are used to weigh the corresponding photons during image generation.

The publication “Stimulated emission depletion microscopy with a single depletion laser using five fluorochromes and fluorescence lifetime phasor separation” (2022) by M. G. Pisfil et al., Nature 12:14017, describes the separation of signals from different fluorescent dyes using phasor analysis in the presence of STED light. A comparison of the phasor plots with and without STED light reveals a shift of the phasor distribution to the right (towards lower lifetimes) and a smearing of the phasor distribution by the STED light. In some samples, the phasor plot evaluation in the presence of STED light did not provide satisfactory separation of the lifetime components. The resulting images are therefore not shown in the publication.

### Objective

The disadvantages of the prior art discussed above give rise to the objective of providing a super-resolution light microscopy method that is capable of reliably and flexibly separating photons from different emitters based on their lifetimes, with reduced optimization effort, for different dyes and samples.

### Solution

This objective is attained by the subject matter of the independent claims. Advantageous embodiments are specified in the dependent claims and are described below.

### DESCRIPTION

A first aspect relates to a light microscopy method in which a sample is illuminated with focused pulsed excitation light to excite at least two types of emitters with different emission lifetimes to emit light, wherein the sample is additionally illuminated with an intensity distribution of inhibition light comprising a local minimum to de-excite emitters outside the local minimum, wherein photons emitted from the sample are detected by a detector, in particular time-resolved, wherein a phasor analysis is performed based on the detected photons to separate photons from the different types of emitters based on their emission lifetime, wherein a gating of the photons is performed, wherein respective gating time intervals are provided for excitation pulses of the excitation light, and wherein only those photons that are detected in the respective gating time interval are taken into account in the phasor analysis.

According to the present disclosure, time gating is combined with a phasor plot analysis to improve the separation of different emitter signals (in particular different dyes in the sample). In contrast, gating in the prior art is used either as an alternative to phasor analysis or for the purpose of increasing the resolution of a STED image by filtering out the early photons, or methods of phasor plot analysis are known to separate early and late photons and thus improve the resolution. An increase in resolution can, of course, be an additional beneficial side effect of the method according to the present disclosure in certain cases.

By omitting the early photons in the phasor plot analysis according to the present disclosure, the smearing of the phasor distribution by the STED effect is reduced or completely eliminated. As a result, the phasor populations assigned to the different emitters are better separated in the phasor plot, and lifetime unmixing is easier and more reliable, particularly for dye combinations and samples that cannot be separated when analyzing all photons in the phasor plot.

The excitation light may be, for example, fluorescence excitation light that excites fluorophores in the sample to fluoresce. However, other excitation mechanisms are also conceivable, as long as the excited emitters emit photons within time periods measurable by the evaluation electronics when they decay back to the ground state.

The excitation light is pulsed, i.e., it is a non-continuous electromagnetic wave or a wave packet with a pulse width. The pulse width and repetition rate may be selected arbitrarily, so the term “pulse” is not limited to specific pulse widths or repetition rates. Typically, the pulse length may range from femtoseconds to picoseconds. Typical values for the repetition rate may be in the MHz range.

The inhibition light may be, for example, STED light, which transfers excited emitters to the ground state without emission. Alternatively, the inhibition light may also be, for example, deactivation light, which transfers emitters to a dark state, as is the case with RESOLFT microscopy.

Different configurations are possible regarding the effect of the excitation light and the inhibition light on the at least two types of emitters.

For example, one type of excitation light may be used that excites several types of emitters, or several types of excitation light with different wavelengths or spectra may be used, each of which excites one type of emitter. In the latter case, the corresponding excitation pulses may, for example, be alternately irradiated into the sample, as is known from the prior art, for example, for so-called pulse-interleaved excitation microscopy (PIE).

The inhibition light (particularly the STED light) may also act on one type of emitter or several types of emitters and de-excite them. If an inhibition light acts only on one type of emitter in the sample, it is possible to irradiate two or more different types of inhibition light with different wavelengths or different spectra, e.g., as alternately irradiated inhibition pulses, which may be temporally delayed relative to the corresponding excitation pulse. However, the method according to the present disclosure is also practicable if only one type of inhibition light is used and a first type of emitter in the sample is excited by the inhibition light, while at least a second type of emitter in the sample is not affected by the inhibition light at all. Even then, the inhibition light can smear the phasors associated with the first type of emitters, for example, so that they overlap in the phasor plot with the phasors associated with the second type of emitters. This effect can then be reduced by the time gating according to the present disclosure, enabling better signal separation.

The gating time intervals may have the same length or different lengths for different respective excitation pulses.

The term “emitter” used here refers to a molecule, a molecular complex, or a particle that emits electromagnetic radiation, particularly in the visible, infrared, or ultraviolet range, when excited by external light. The emitter may, for example, be a fluorophore or be coupled (i.e., covalently or non-covalently bound) to a fluorophore that emits fluorescent light when excited by a light pulse of suitable wavelengths. Alternatively, the emitter may be, for example, a quantum dot. In addition to fluorescence, other mechanisms are also conceivable within the scope of the present disclosure for exciting the at least one emitter to emit a photon. For example, emitted photons may be a result of light scattering. Another example is photoactivation, which may consist of converting the at least one emitter from a first, e.g., non-fluorescent state or dark state to a second, light-emitting state, e.g., by the at least one emitter emitting fluorescence in response to excitation light in the second state.

The emission lifetime is defined here as a parameter that indicates the typical (or average) time after which a photon is emitted following a light pulse. In the case of fluorescence emission by the emitters in response to excitation light, the emission lifetime is the fluorescence lifetime. If the light emission can be described as a monoexponential process, for example, the emission lifetime is defined in particular as the reciprocal of the time constant of a monoexponential decay. For an ensemble of emitters, this lifetime describes the time after which the light intensity of the light emission has decreased to a fraction of 1/e of the initial intensity value. In the case of a single emitter, the emission of a photon after being triggered by the light pulse follows a probability distribution that can be described, for example, by a monoexponential decay, and the emission lifetime is the time after which the probability that a particular emitter has emitted a photon is equal to 1-1/e.

The intensity distribution may be, for example, a donut, in which the local minimum is surrounded by intensity increase areas in the focal plane, i.e., laterally (but not along the optical axis, i.e., axially), or, for example, a so-called bottle beam (sometimes also referred to as a 3D donut), in which the local minimum is surrounded by intensity increase areas both laterally and axially. A donut can be formed, for example, by phase modulation of the illumination light in or near a pupil plane conjugate to the rear aperture of the microscope objective with a vortex phase pattern (also known as a phase clock). A bottle beam can be generated by phase modulation of the illumination pattern with a ring-shaped phase pattern in or near the pupil plane. Finally, intensity distributions with a flat local minimum (sometimes also referred to as a crescent-shaped intensity distribution) can be achieved by phase modulation with a singly segmented phase pattern. The local minimum may be an intensity zero point. Under real conditions, however, the intensity at the local minimum is often not zero, e.g., due to optical aberrations. The local minimum may be centrally located, i.e., at the geometric focus. In this case, the intensity distribution may be arranged symmetrical around the local minimum.

The term “phasor analysis” refers to a pixel-by-pixel evaluation of the arrival time distribution of photons, in which at least one Fourier coefficient (in particular a real part and/or an imaginary part of a phasor) is formed for each pixel. In phasor analysis, a phasor plot can be displayed to a user, but this is not mandatory, as phasor analysis and separation of emitter signals can also be performed automatically in the background.

The term “gating” refers here to the exclusion or non-consideration of certain photons depending on their arrival time in phasor analysis. So-called “physical gating” can be used here, i.e., the photons are not detected in a certain time interval, e.g., because the detection beam path is shaded or the detection light is deflected or blocked so that it does not reach the detector, or because the detector is deactivated during the corresponding period. Alternatively, so-called “electronic gating” can be used. In this case, all photons are detected and registered, and gating takes place at the level of a downstream electronic circuit or is performed by data analysis.

According to one embodiment, a zero point of a time scale underlying the phasor analysis is set to a starting time point of the gating time interval. In other words, the phasors are normalized to the start of the gating time interval. Specifically, for example, when determining the Fourier coefficients or the real part and the imaginary part of the phasors, the lower limit of the summation or integration can be set to the starting time point of the gating time interval.

According to a further embodiment, the inhibition light is irradiated onto the sample in inhibition pulses, wherein a temporal distance between an excitation pulse and a starting time point of the respective gating time interval overlaps in time with a respective inhibition pulse. This allows at least some of the photons emitted during the effect of the respective inhibition pulse on the emitters in the sample to be excluded from the phasor analysis. Depending on the type of inhibition pulse, in particular depending on how quickly the effect of the inhibition pulse occurs on the emitters, it may be advantageous if the gating time interval has a certain temporal distance relative to the respective inhibition pulse.

According to a further embodiment, the temporal distance between an excitation pulse and the starting time point of the respective gating time interval corresponds to at least one pulse length of the respective inhibition pulse. Advantageously, all photons emitted during an inhibition pulse are excluded from the phasor plot analysis. Depending on the speed of the effect of the inhibition pulses, it may also be advantageous if the temporal distance is longer than the pulse length of the inhibition pulse and the gating time interval only begins after the end of the inhibition pulse with a certain temporal distance relative to it.

According to a further embodiment, the inhibition pulses are irradiated onto the sample with a pulse delay relative to a preceding excitation pulse, wherein the temporal distance between an excitation pulse and the starting time point of the respective gating time interval corresponds at least to the sum of the pulse length of the inhibition pulse and the pulse delay. The pulse delay results in a particularly high effectiveness of the de-excitation of the emitters in areas outside the minimum of the intensity distribution. In this case, the said temporal distance is advantageously longer than the inhibition pulse so that the gating time interval only begins after the end of the inhibition pulse.

According to a further embodiment, the photons emitted by the sample are detected by the detector only during the gating time interval or are registered by an evaluation device coupled to the detector only during the gating time interval. This embodiment comprises, in particular, so-called physical gating, in which, for example, the detection light may be shielded or deflected, or the detector or electronics coupled to the detector may be switched off.

According to a further embodiment, the photons emitted by the sample between an excitation pulse and the start of the respective gating time interval are detected and recorded, but excluded from a data set used in phasor analysis. In this case, gating is performed electronically, at the data processing level.

According to a further embodiment, the sample is scanned with a focus of the excitation light, with which the intensity distribution of the inhibition light is superimposed, wherein photons detected for respective positions of the focus in the sample are assigned to respective image pixels. The focus may be moved in particular by confocal laser scanning of the excitation light and the inhibition light over or through the sample. In particular, in phasor analysis, respective phasors are calculated for the respective image pixels.

According to a further embodiment, the detector is coupled to an evaluation device, wherein based on a signal pulse sequence of photon signals transmitted from the detector to the evaluation device real parts and imaginary parts of respective phasors, based on which the phasor analysis is performed, are calculated by the evaluation device, in particular without storing individual photon signals.

In this embodiment, the phasors required for separating the different types of emitters are thus obtained quickly without the recorded photons with their individual arrival times being known retrospectively for data analysis. This advantageously reduces the data streams and the requirements on the processors used, in particular in experiments with many data points (pixels).

The evaluation device may comprise one unit or several units coupled together. For example, the evaluation device may comprise TCSPC electronics configured to determine the arrival times of individual photons detected by the detector. Instead or in addition, the evaluation device may also comprise, for example, a microprocessor, an FPGA (field programmable gate array) or similar, e.g. to quickly calculate phasors from a data stream during measurement in the context of the embodiment described above, without having to store the individual photon arrival times.

According to a further embodiment, a real part and an imaginary part is calculated for each image pixel by the evaluation device.

According to a further embodiment, the inhibition light, in particular the inhibition pulses, acts at least on first emitters in the sample by de-exciting the first emitters outside the local minimum of the inhibition light, wherein the first emitters have a longer emission lifetime than second emitters in the sample. In this configuration, there may be a particularly severe deterioration in the separability of the two emitters, since the phasor of the longer-lived first emitters is blurred by the inhibition light into an ensemble of shorter-lived species whose phasors in the phasor plot may overlap with the population of phasors of the shorter-lived second emitters.

A second aspect relates to a light microscopy device, in particular for carrying out a method according to the first aspect, wherein the device comprises at least the following components: an illumination device configured to illuminate a sample with focused pulsed excitation light to excite at least two types of emitters with different emission lifetimes to emit light, and additionally illuminating the sample with an intensity distribution of inhibition light comprising a local minimum to de-excite emitters outside the local minimum, a detector configured to detect photons emitted by the sample, in particular in a time-resolved manner, and a computing unit configured to perform a phasor analysis based on the detected photons to separate photons from the different types of emitters based on their emission lifetimes, wherein the light microscopy device, in particular an evaluation device or the computing unit of the light microscopy device, is configured to perform a gating of the photons by providing respective gating time intervals for excitation pulses of the excitation light, wherein the computing unit is configured to take into account in the phasor analysis only those photons that are detected in the respective gating time interval.

A third aspect relates to a non-transitory computer-readable medium for storing computer instructions that when executed by one or more processors associated with a light microscopy device, cause the one or more processors to perform the method according to the first aspect.

Further advantages and embodiments of the light microscopy device according to the second aspect and the computer program according to the third aspect result analogously from the description of the method according to the first aspect.

### BRIEF DESCRIPTION OF THE FIGURES

FIG. 1 shows schematically an example of an arrival time distribution of detected photons with time gating and a phasor plot derived therefrom;

FIG. 2 shows a light microscopy device according to an embodiment;

FIG. 3 shows a light microscopy device according to a further embodiment.

### DESCRIPTION OF THE FIGURES

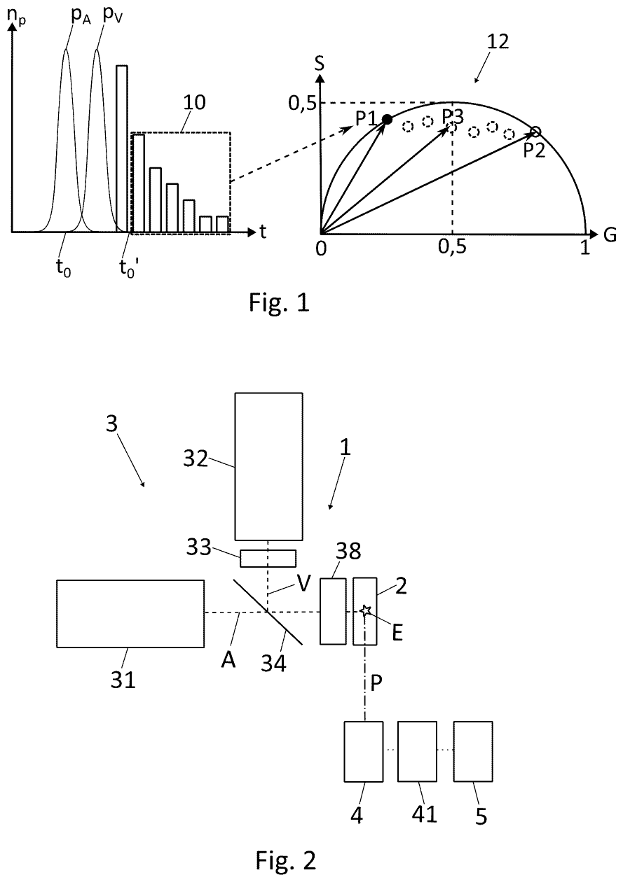

FIG. 1 schematically illustrates an embodiment of the method according to the present disclosure, in which a sample 2 comprising at least two different types of emitters E is illuminated with focused excitation light A in the form of excitation pulses p_{A} and with an intensity distribution of inhibition light V (in particular STED light) superimposed on the focus of the excitation light A with a local minimum (in particular a central zero point) in the form of inhibition pulses p_{V} superimposed on the focus of the excitation light A, and individual photons emitted from sample 2 are detected in a time-resolved manner, wherein the inhibition light V transfers at least one type of emitter E in the sample 2 from a state excited by the excitation light A to a ground state in a region outside the local minimum. In particular, the focus of the excitation light A and the intensity distribution of the inhibition light V are scanned over the sample 2 using a scanning device, and the number of detected photons and the arrival times of the individual photons are determined pixel by pixel.

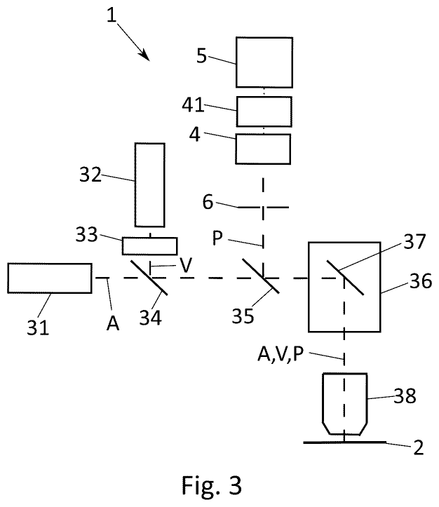

The left diagram in FIG. 1 shows on a time axis t an excitation pulse p_{A}, an inhibition pulse p_{V} delayed relative to the excitation pulse p_{A}, and a frequency distribution (frequency np) of arrival times of photons emitted from a sample 2 (see FIG. 2 and FIG. 3) due to the excitation light A, which were detected by a detector 4 (see FIG. 2 and FIG. 3). The right-hand diagram in FIG. 1 shows a phasor plot 12 with example phasors P1, P2, P3, which were calculated based on the photons detected in the gating time interval 10 (see left-hand diagram).

The photons detected before the gating time interval 10 were not taken into account in the calculation of the phasors P1, P2, P3. The gating time interval 10 begins at time t₀′. The temporal distance between the excitation pulse p_{A} and the starting time point t₀′ of the gating time interval corresponds in this example to the duration of the inhibition pulse p_{V}. By omitting the photons emitted by the emitters before the gating time interval 10, the phasor analysis can be performed largely free of the effects of the inhibition light (e.g., smearing of the phasor distribution due to the reduction in emission lifetime caused by the inhibition pulse p_{V}). This improves the separability of different phasor populations associated with the different types of emitters in the sample.

When calculating the phasors, the real parts of the phasors can be determined by calculating the cosine transform

$$g ( ω ) = \frac{{\int }_{{t}_{0}^{′}}^{∞} I ( t ) cos ( ω t )}{{\int }_{{t}_{0}^{′}}^{∞} I ( t )}$$

and the imaginary parts of the phasors by calculating the sine transform

$$s ( ω ) = \frac{{\int }_{{t}_{0}^{′}}^{∞} I ( t ) sin ( ω t )}{{\int }_{{t}_{0}^{′}}^{∞} I ( t )} ,$$

wherein ω is the repetition rate of the excitation pulses p_{A}, I(t) is the temporal intensity curve of the signal, and t₀′ is the starting time point of the gating time interval 10.

The phasors P1 and P2 shown as examples in the phasor plot 12 are located on the semicircle with center (0.5;0) and radius 0.5 and correspond to respective signals with a single emission lifetime, as would be expected at sample positions where there is only one type of emitter E with monoexponential decay behavior. The phasor P3 is approximately located on a line between the phasor P1 and the phasor P2 and is thus an example of a phasor of a mixed signal of the emitters with the corresponding emission lifetimes. For the pixel to which phasor P3 is assigned, the proportions of the two types of emitters can be determined by determining the position of phasor P3 on the line between phasors P1 and P2, and the corresponding photon numbers can be assigned to different detection channels for this pixel. This separation of signals works better with the gating according to the present disclosure, since the effects of the inhibition light V are at least reduced in the phasor analysis.

FIG. 2 shows a first embodiment of a light microscopy device 1 according to the present disclosure comprising an illumination device 3 for illuminating a sample 2 with excitation light A and inhibition light V, as well as a detector 4 for time-resolved detection of photons P emitted from the sample 2 and a computing unit 5 for performing a phasor analysis based on the photons P detected by the detector 5. The illumination device 3 comprises a first light source 31, in particular a laser, for generating the excitation light A in the form of excitation light pulses p_{A}, a second light source 32, in particular a further laser, for generating inhibition light V (in particular STED light) in the form of inhibition pulses p_{V}, a light modulator 33 (e.g., a so-called spatial light modulator, SLM) for influencing a spatial phase and/or amplitude distribution of the inhibition light V, a beam combiner 34 (e.g., a dichroic mirror) for combining the excitation light A with the inhibition light V, and an objective 38 focusing the excitation light A and the inhibition light V into a sample 2 with at least two different types of emitters E (e.g., fluorophores with different emission lifetimes). The light modulator 33 and the objective 38 interact in such a way that an intensity distribution of the inhibition light V with a central intensity zero point (which is superimposed on the intensity maximum of the excitation light A) is formed at the common focus of the excitation light A and the inhibition light V in the sample 2. The intensity distribution may be, for example, a donut, a bottle beam, or a so-called crescent light distribution. Photons P emitted from sample 2 are detected by a detector 4 (e.g., a single-photon avalanche photodiode, SPAD) and recorded in a time-resolved manner by an evaluation device 41 (e.g., comprising TCSPC electronics) coupled to the detector 4. The evaluation device 41 is coupled to the computing unit 5.

The evaluation device 41 may transmit arrival times of individual photons P to the computing unit 5. The computing unit 5 may then perform a phasor analysis based on the arrival times of the photons P detected in the gating time interval 10 (see FIG. 1) to separate the signals of the different types of emitters E in the sample 2.

The gating may be performed, for example, as electronic gating by the evaluation device 41 or also by the computing unit 5.

According to an alternative, the real and imaginary parts of the phasors are already determined from a data stream coming from the TCSPC electronics by the evaluation device 41, which in this case may comprise, for example, an FPGA connected to the TCSPC electronics, and these values are transmitted to the computing unit 5. This has the advantage that the arrival time does not have to be stored for each individual photon.

FIG. 3 shows a second embodiment of the light microscopy device 1 according to the present disclosure, which is configured here as a confocal laser scanning microscope and/or STED microscope. Components that are identical or analogous to those in the embodiment of FIG. 2 are designated with the same reference numbers. For these, reference is made to the above description of FIG. 2. In the light microscopy device 1 according to FIG. 3, the focused excitation light A and the intensity distribution of the inhibition light V are scanned over the sample 2, the objective 38 also collects the emitted photons P emanating from the sample 2, and the photons P are detected confocally. For this purpose, a beam splitter 35 (in particular, another dichroic mirror) and a scanning device 36 (e.g., a galvanometer scanner) with at least one controllable, movable scanning mirror 37, in particular at least one scanning mirror for each spatial direction of the scan (not shown). The scanning device 36 scans the common focus of the excitation light A and the inhibition light V across the sample 2.

The photons P emitted from the sample 2 are focused by the objective 38, scanned by the scanning device 36, and reflected by the beam splitter 35 depending on their wavelength. The reflected light passes through a confocal pinhole 6 to the detector 4, which detects the photons P, which are recorded pixel by pixel in a time-resolved manner by the evaluation device 41.

List of reference symbols

| | |
|---|---|
| 1 | Light microscopy device |
| 2 | Sample |
| 3 | Illumination device |
| 4 | Detector |
| 5 | Computing unit |
| 6 | Pinhole |
| 10 | Gating time interval |
| 12 | Phasor plot |
| 31 | First light source |
| 32 | Second light source |
| 33 | Light modulator |
| 34 | Beam combiner |
| 35 | Beam splitter |
| 36 | Scanning device |
| 37 | Scanning mirror |
| 38 | Objective |
| 41 | Evaluation device |
| A | Excitation light |
| E | Emitter |
| P | Photons |
| V | Inhibition light |
| p_{A} | Excitation pulse |
| p_{S} | Inhibition pulse |
| t₀′ | Starting time point of the gating time interval |

1. A light microscopy method, wherein a sample is illuminated with focused pulsed excitation light to excite at least two types of emitters with different emission lifetimes to emit light, wherein the sample is additionally illuminated with an intensity distribution of inhibition light comprising a local minimum to de-excite emitters outside the local minimum, wherein photons emitted from the sample are detected by a detector, wherein a phasor analysis is performed based on the detected photons to separate photons from the different types of emitters based on their emission lifetime,
wherein a gating of the photons is performed, wherein a respective gating time interval is provided for a respective excitation pulse of the excitation light, and wherein only those photons that are detected in the respective gating time interval are taken into account in the phasor analysis.

2. The method according to claim 1, wherein a zero point of a time scale underlying the phasor analysis is set to a starting time point of the gating time interval.

3. The method according to claim 2, wherein the inhibition light is irradiated onto the sample in inhibition pulses, wherein a temporal distance between the excitation pulse and the starting time point of the gating time interval overlaps in time with a respective inhibition pulse.

4. The method according to claim 2, wherein a temporal distance between the excitation pulse and the starting time point of the gating time interval corresponds to at least one pulse length of the respective inhibition pulse.

5. The method according to claim 3, wherein the inhibition pulses are irradiated onto the sample with a pulse delay relative to a respective preceding excitation pulse, wherein the temporal distance between the excitation pulse and the starting time point of the respective gating time interval corresponds at least to the sum of the pulse length of the inhibition pulse and the pulse delay.

6. The method according to claim 4, wherein the inhibition pulses are irradiated onto the sample with a pulse delay relative to a respective preceding excitation pulse, wherein the temporal distance between the excitation pulse and the starting time point of the respective gating time interval corresponds at least to the sum of the pulse length of the inhibition pulse and the pulse delay.

7. The method according to claim 1, wherein the photons emitted by the sample are detected by the detector only during the gating time interval or are registered by an evaluation device coupled to the detector only during the gating time interval.

8. The method according to one of claim 1, wherein the photons emitted by the sample are detected and registered between an excitation pulse and the starting time point of the respective gating time interval, but are excluded from a data set used in the phasor analysis.

9. The method according to claim 1, wherein the sample is scanned with a focus of the excitation light, with which the intensity distribution of the inhibition light is superimposed, wherein photons detected for respective positions of the focus in the sample are assigned to respective image pixels.

10. The method according to claim 5, wherein the sample is scanned with a focus of the excitation light, with which the intensity distribution of the inhibition light is superimposed, wherein photons detected for respective positions of the focus in the sample are assigned to respective image pixels.

11. The method according to claim 6, wherein the sample is scanned with a focus of the excitation light, with which the intensity distribution of the inhibition light is superimposed, wherein photons detected for respective positions of the focus in the sample are assigned to respective image pixels.

12. The method according to claim 9, wherein the detector is coupled to an evaluation device, wherein based on a signal pulse sequence of photon signals transmitted from the detector to the evaluation device, real parts and imaginary parts of respective phasors, based on which the phasor analysis is performed, are calculated by the evaluation device without storing individual photon signals.

13. The method according to claim 10, wherein a real part and an imaginary part of a phasor is calculated for each image pixel by the evaluation device.

14. The method according to claim 1, wherein the detector is coupled to an evaluation device, wherein based on a signal pulse sequence of photon signals transmitted from the detector to the evaluation device, real parts and imaginary parts of respective phasors, based on which the phasor analysis is performed, are calculated by the evaluation device without storing individual photon signals.

15. The method according to claim 1, wherein the inhibition light acts at least on first emitters in the sample by de-exciting the first emitters outside the local minimum of the inhibition light, wherein the first emitters have a longer emission lifetime than second emitters in the sample.

16. The method according to claim 5, wherein the inhibition light acts at least on first emitters in the sample by de-exciting the first emitters outside the local minimum of the inhibition light, wherein the first emitters have a longer emission lifetime than second emitters in the sample.

17. The method according to claim 6, wherein the inhibition light acts at least on first emitters in the sample by de-exciting the first emitters outside the local minimum of the inhibition light, wherein the first emitters have a longer emission lifetime than second emitters in the sample.

18. The method according to claim 1, wherein the inhibition light is STED light.

19. A light microscopy device comprising at least the following components:
an illumination device configured to illuminate a sample with focused pulsed excitation light to excite at least two types of emitters with different emission lifetimes to emit light, and additionally illuminating the sample with an intensity distribution of inhibition light comprising a local minimum to de-excite emitters outside the local minimum,
a detector configured to detect photons emitted from the sample, and
a computing unit configured to perform a phasor analysis based on the detected photons to separate photons from the different types of emitters based on their emission lifetimes,
wherein the light microscopy device is configured to perform a gating of the photons by providing respective gating time intervals for excitation pulses of the excitation light, wherein the computing unit is configured to take into account in the phasor analysis only those photons that are detected in the respective gating time interval.

20. A non-transitory computer-readable medium for storing computer instructions that when executed by one or more processors associated with a light microscopy device, cause the one or more processors to perform the method according to claim 1.
